(19) United States
(12) Patent Application Publication
(10) Pub. No.: US 2005/0227808 A1
(43) Pub. Date: Oct. 13, 2005

(54) Continuously variable toroidal transmission with offset rollers

(76) Inventor: Todd Brooks, Prior Lake, MN (US)

Correspondence Address: Roger L. Belfay, 829 Tuscarora Avenue, Saint Paul, MN, 55102, US

(21) Appl. No.: 10/814,542

(22) Filed: Mar. 31, 2004

(51) Int. Cl. F16H 15/38

(52) U.S. Cl. 476/40

(57) ABSTRACT

A continuously variable transmission comprising; a drive disk; a driven disk, a plurality of rollers, and tubular support member. Each roller is rotatably attached to a shaft which is pivotally attached to a stanchion, which is fixed to one face of the tubular support member. One face of each disk contains an annular cavity. Said faces are positioned to form a toroid around the longitudinal axis. The rollers are rotatably placed within the toroidal chamber in contact with both the driven and driving disks. The annular fixing of center of rotation of the rollers permits the driving disk to impart rotation to the rollers and thereby to the driven disk. Tubular support member longitudinal movement changes the plane of rotation of the rollers relative to the longitudinal axis causing a difference in the rate of rotation of the driven disk relative the rate of rotation of the driving disk.

### BACKGROUND OF INVENTION

The Continuously variable toroidal transmission with offset rollers is a continuously variable transmission wherein speed differential between a driven and driving disk is established by tilting a set of rollers within the toroid formed by opposing faces of driving and driven disks. Varying the positioning of the roller support mechanism along the longitudinal axis of the transmission controls the tilt angle of the rollers by forcing the rollers against one side of the toroid formed by the driven and driving disks. Continuously variable toroidal transmissions known in the art naturally fall into two groups: those using essentially disk like rollers to transmit torque from the driving disk to the driven disk and those using spherical rollers to transmit torque from the driving to the driven disk. The cylindrical face of the essentially disk shaped roller is generally curved outwardly from the axis of rotation of the cylinder producing what would be single point contact with the driving and driven disks absent surface deformation produced by the pressure of said contact. The continuously variable toroidal transmission with offset rollers falls within the class using essentially disk shaped rollers to transfer torque from the driving disk to the driven disk. In both these classes of transmission an essential problem involves controlling the angle formed between the roller's plane of rotation and the common axis of rotation shared by the driving and driven disks, herein referred to as the tilt angle. The known transmissions, of this type, include a mechanism, which controls the tilt angle by rotating the roller's plane of rotation about the roller's center point. The roller's plane of rotation rotates about a pivot point placed outside the roller's plane of rotation in the continuously variable toroidal transmission with offset rollers. This change enables control of the tilt angle by varying the position of the roller support mechanism along the common axis of rotation of the driving and driven disks. Movement of the tubular support member axially along the transmissions center of rotation forces the rollers against one side of the toroid formed by the hollowed faces of the driven and driving disks. Since the rollers are rotationally mounted on a shaft which in turn is pivotally attached to the stanchions which support the rollers from the tubular support member, the axial movement of the tubular support member cause the roller to pivot around the pivot point formed by the shaft and stanchion. This rotation produces a change in the tilt angle and thereby a change the speed and torque ratios of the transmission. An advantage, therefore, of the continuously variable toroidal transmission with offset rollers is the reduced complexity of the mechanism required to control the tilt angle.

### BRIEF SUMMARY OF THE INVENTION

The object of the Continuously variable toroidal transmission with offset rollers is a simplified and therefore lighter weight continuously variable transmission. The Continuously variable toroidal transmission with offset rollers is a continuously variable transmission wherein speed differential between a driven and driving disk is established by tilting one or more rollers within the toroid formed by opposing faces of driving and driven disks. Varying the positioning of the roller support mechanism along the longitudinal axis of the transmission controls the tilt angle of the rollers.

An advantage of the continuously variable toroidal transmission with offset rollers is the reduced complexity of the mechanism required to control the tilt angle.

### BRIEF DESCRIPTION OF THE DRAWINGS

FIG. 1—Section view of the continuously variable toroidal transmission with offset rollers along the axis of rotation common to the driving and driven disks (show a roller section at top, no roller section at bottom) with the rollers in a 1:1 speed relationship.

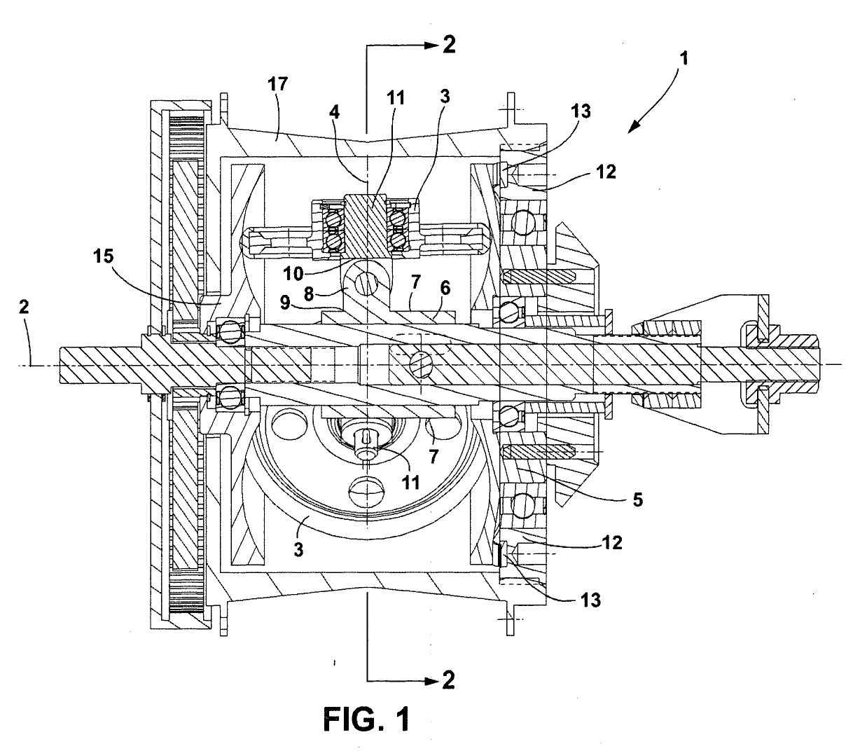

FIG. 2—Section view of the continuously variable toroidal transmission with offset rollers through the rollers perpendicular to the axis of rotation common to the driving and driven disks.

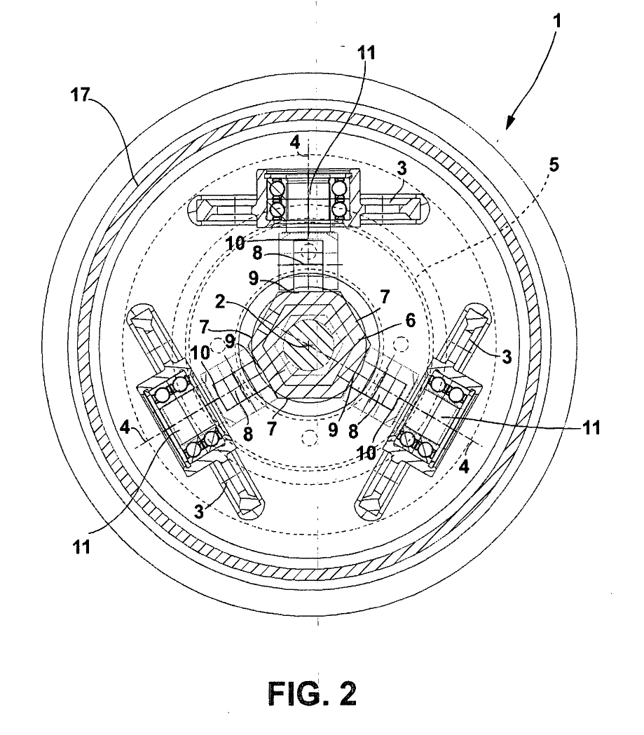

FIG. 3—A view of a bicycle with the continuously variable toroidal transmission with offset rollers installed in the rear wheel assembly.

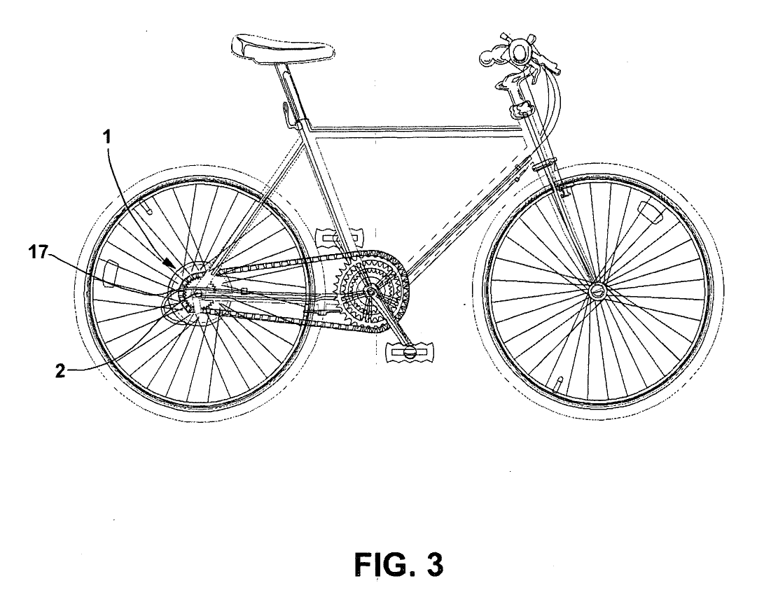

FIG. 4—An exploded view of the continuously variable toroidal transmission with offset rollers showing all parts and their relative positions for assembly.

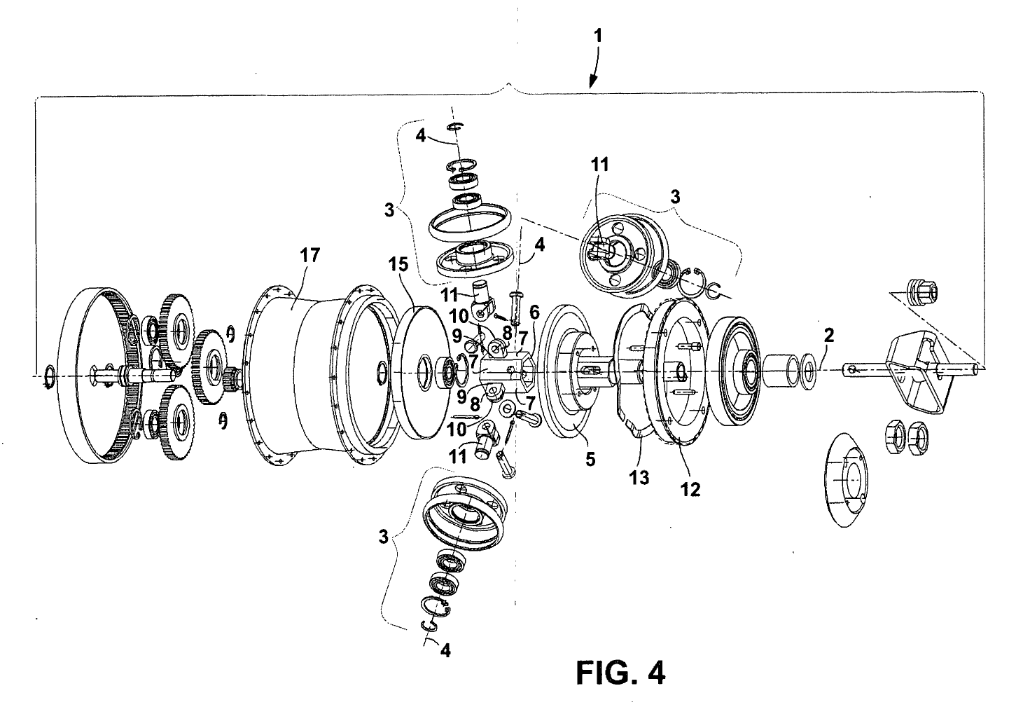

### DETAILED DESCRIPTION

The continuously variable toroidal transmission with offset rollers 1 is a continuously variable transmission having a longitudinal axis 2 comprising; a plurality of rollers 3, each having a tiltable axis of rotation 4, and each roller located radially outward from the longitudinal axis 2; a drive disk 5 annularly rotatable about the longitudinal axis 2 and contacting a first point on each of the rollers 3 and having a first side facing the rollers 3 and a second side facing away from the rollers 3; a driven disk 15 annularly rotatable about the longitudinal axis 2 and contacting a second point on each of the rollers 3; a tubular support member 6 with a plurality of faces 7 annularly rotatable about the longitudinal axis 2 and capable of longitudinal movement along the longitudinal axis 2; a set of roller support stanchions 8 each with a first end 9 and a second end 10, said first end 9 being affixed to one of the tubular support member faces 7; a set of rollers 3, each rotatably mounted to a first end of a roller support shaft 11, said roller support shaft being pivotally attached to said second end of said roller support stanchion 8; a bearing disk 12 annularly rotatable about the longitudinal axis 2, and adapted to provide rotational force to the drive disk 5; at least one axial force generator 13, the axial force generator 13 located between the drive disk 5 and the bearing disk 12, the axial force generator 13 configured to apply a component of axial force to the drive disk 5, thereby, improving the contact of the drive disk 5 and the rollers 3 as well as between the rollers 3 and the driven disk 15.

External connections to the he tubular support member 6 cause axial motion of the tubular support member 6 to control the speed ratio between the drive disk 5 and the driven disk 15. Suitable means such as slots or flat surfaces mated to the tubular support member 6 prevent the tubular support member 6 from annular rotation to assure that forces applied to the rollers 3 by the drive disk 5 result in application of opposite forces to the driven disk 15.

The continuously variable toroidal transmission with offset rollers 1 may be used on many applications where fine control of the input and output speed or torque ration must be controlled such as in bicycle wheel hub assemblies 17.

1) A continuously variable transmission having a longitudinal axis comprising;
a plurality of rollers, each having a tiltable axis of rotation, and each roller located radially outward from the longitudinal axis;
a drive disk annularly rotatable about the longitudinal axis and contacting a first point on each of rollers and having a first side facing the rollers and a second side facing away from the rollers;
a driven disk annularly rotatable about the longitudinal axis and contacting a second point on each of the rollers;
a tubular support member with a plurality of faces annularly rotatable about the longitudinal axis and capable of longitudinal movement along the longitudinal axis;
a set of roller support stanchions each with a first end and a second end, said first end being affixed to one of the tubular support member faces;
a set of rollers, each rotatably mounted to a first end of a roller support shaft, said roller support shaft being pivotally attached to said second end of a roller support stanchion.
a bearing disk annularly rotatable about the longitudinal axis, and adapted to provide rotational force to the drive disk;
at least one axial force generator, the axial force generator located between the drive disk and the bearing disk, the axial force generator configured to apply a component of axial force to the drive disk, thereby, improving the contact of the drive disk and the rollers as well as between the rollers and the driven disk.

2) the continuously variable transmission of claim 1 wherein the tubular support member is hexagonal in cross section.

3) the continuously variable transmission of claim 1 wherein the tubular support member is circular in cross section.

4) the continuously variable transmission of claim 1 wherein the tubular support member is oval in cross section.

5) the continuously variable transmission of claim 1 wherein the tubular support member is triangular in cross section.

6) the continuously variable transmission of claim 1 wherein the stanchions are affixed to each face of the tubular support member.

7) the continuously variable transmission of claim 1 wherein the stanchions are affixed to less than all the faces of the tubular support member.

8) the continuously variable transmission of claim 1 wherein the stanchions are affixed to less than all of the faces of the tubular support member.

9) the continuously variable transmission of claim 1 wherein the stanchions are affixed to three faces of the tubular support member.

10) the continuously variable transmission of claim 9 wherein the tubular support member is hexagonal in cross section.

11) the continuously variable transmission of claim 10 wherein the three stanchions are attached to three faces of the tubular support member and are spaced equally about the longitudinal axis.
